(19) United States
(12) Patent Application Publication
(10) Pub. No.: US 2023/0043384 A1
(43) Pub. Date: Feb. 9, 2023

(54) APPARATUS FOR CONTROLLING OTA UPDATE OF VEHICLE AND METHOD THEREOF

(71) Applicants: Hyundai Motor Company, Seoul (KR); Kia Corporation, Seoul (KR)

(72) Inventors: Sun Ho CHOI, Hwaseong-Si (KR); Hyun Soo AHN, Suwon-Si (KR)

(73) Assignees: Hyundai Motor Company, Seoul (KR); Kia Corporation, Seoul (KR)

(21) Appl. No.: 17/668,602

(22) Filed: Feb. 10, 2022

(30) Foreign Application Priority Data
Jul. 28, 2021 (KR) 10-2021-0099394

(51) Int. Cl. G06F 8/65

(52) U.S. Cl. CPC G06F 8/65

(57) ABSTRACT

An apparatus of controlling an over-the-air (OTA) update of a vehicle and a method thereof, includes a controller that collects vehicle information and battery information from a plurality of vehicles, and determines an optimal OTA update-target for each of the vehicles, based on the vehicle information and the battery information, and a communication device that transmits the optimal OTA update-target and corresponding update data to each of the vehicles.

### CROSS-REFERENCE TO RELATED APPLICATION

The present application claims priority to Korean Patent Application No. 10-2021-0099394, filed on Jul. 28, 2021, the entire contents of which is incorporated herein for all purposes by this reference.

### BACKGROUND OF THE INVENTION

### Field of the Invention

The present invention relates to technology for controlling an over-the-air (OTA) update of an electronic control unit (ECU) positioned in a vehicle.

### Description of Related Art

There is a rapid increase in the type and number of electronic components used for a vehicle, thus increasing the type and number of electronic apparatuses mounted on the vehicle. The electronic apparatus may be used roughly in a power train control system, a body control system, a chassis control system, a vehicle network, a multimedia system, etc. The power train control system may include an engine control system, an automatic transmission control system, etc. The body control system may include a body electrical-equipment control system, a convenience device control system, a lamp control system, etc. The chassis control system may include a steering actuator control system, a brake control system, a suspension control system, etc. The vehicle network may include a controller area network (CAN), a FlexRay-based network, a media oriented system transport (MOST)-based network, etc. The multimedia system may include a navigator system, a telematics system, an infotainment system, etc.

The system and the electronic apparatus included in each system may be connected to each other through the vehicle network, and there is thus a need for the vehicle network supporting each function of the electronic apparatus. The CAN may have a transmission rate of up to 1 Mbps, may automatically retransmit a collided frame, and may perform error detection based on cyclic redundancy check (CRC). The FlexRay-based network may have a transmission rate of up to 10 Mbps, may simultaneously transmit data through two channels, may perform synchronous data transmission, etc. The MOST-based network may be a communication network for high-quality multimedia and may have a transmission rate of up to 150 Mbps.

Meanwhile, the telematics system, infotainment system, advanced safety system or the like of the vehicle may each require a high transmission rate, system scalability, etc. However, the CAN, the FlexRay-based network or the like fails to fully satisfy these requirements. The MOST-based network may have a higher transmission rate compared to the CAN and the FlexRay-based network. However, it may require a lot of cost to use the MOST-based network in all networks of the vehicle. An Ethernet-based network may be considered as the vehicle network because of these problems. The Ethernet-based network may support bidirectional communications by use of a pair of windings, and may have a transmission rate of up to 10 Gbps.

In recent years, there is an increasing demand for an over-the-air (OTA) update of an electronic control unit (ECU) positioned in the vehicle, and various methods have thus been provided for updating each ECU connected to the vehicle network.

A battery capacity (or capacity (Ah), and Ah=A (current)×h (hour)) consumed for the OTA update may depend on a vehicle type and an option for each vehicle type. Here, there are more than hundreds of vehicle types, and there may be thousands of detailed vehicle types when the vehicle type is classified in detail in consideration of the option mounted on the vehicle. It is thus difficult for a worker to separately set up a reference current for each of these thousands of vehicle types. Moreover, as the vehicle gets an older model year, it becomes more difficult to accurately determine an amount of power consumed by the vehicle, which makes it impossible to detect with high accuracy whether or not the OTA update may be performed on the vehicle.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing an apparatus of controlling an over-the-air (OTA) update of a vehicle and a method thereof, the apparatus being configured for determining an optimal OTA update-target even for a different vehicle type and a different option for each vehicle type by collecting vehicle information and battery information from a plurality of vehicles, and by determining the optimal OTA update-target for each of the vehicles based on the vehicle information and the battery information.

Various aspects of the present invention provide an apparatus of controlling the OTA update of a vehicle and a method thereof, the apparatus being configured for determining an optimal update-target electronic control unit (ECU) even for a different vehicle type and a different option for each vehicle type by collecting vehicle information and battery information from the plurality of vehicles, by detecting a reference current corresponding to the vehicle information and a spare capacity corresponding to the battery information, by determining an amount of power consumed by each update-target ECU for each update time, and by determining a final update-target ECU in descending order of priority, based on the amount of power consumed by each update-target ECU, compared to the spare capacity.

The technical problems to be solved by the present invention are not limited to the aforementioned problems, and any other technical problems of the present invention not mentioned herein will be understood from the following description and will be apparent from embodiments of the present invention. Furthermore, it may be easily understood that the technical problems of the present invention may be solved by a method(s) included in the claims and a combination thereof.

According to various aspects of the present invention, an apparatus of controlling an over-the-air (OTA) update of a vehicle, includes a controller that collects vehicle information and battery information from the plurality of vehicles, and determine an optimal OTA update-target for each of the vehicles, based on the vehicle information and the battery information, and a communication device that transmits the optimal OTA update-target and corresponding update data to each of the vehicles.

In various exemplary embodiments of the present invention, the controller may detect a reference current corresponding to the vehicle information and a spare capacity corresponding to the battery information, may determine an amount of power consumed by each update-target electronic control unit (ECU) for each update time, and may determine a final update-target ECU in descending order of priority, based on the amount of power consumed by each update-target ECU, compared to the spare capacity.

In various exemplary embodiments of the present invention, the controller may determine, as the spare capacity, a result capacity obtained by subtracting a standby power capacity and a starting power capacity from an available power capacity corresponding to a state of charge (SOC) value of a battery.

In various exemplary embodiments of the present invention, the controller may be configured to determine a final spare capacity by further considering durability of the battery in addition to the spare capacity.

In various exemplary embodiments of the present invention, the controller may be configured to determine the amount of power consumed by each update-target ECU, based on the reference current of each of the vehicles and estimated time required for updating each update-target ECU positioned in each of the vehicles.

In various exemplary embodiments of the present invention, the controller may be configured to determine an ECU that satisfies the spare capacity of a battery as the final update-target ECU, based on the priority of each update-target ECU in the OTA update, in a process in which the amounts of power consumed by the ECUs for the OTA update are summed together in order of an ECU having higher priority to an ECU having lower priority.

In various exemplary embodiments of the present invention, the vehicle information may include at least one of information on a vehicle type or information on an option for each vehicle type.

In various exemplary embodiments of the present invention, the battery information may include at least one of state of charge (SOC), temperature or durability of a battery.

In various exemplary embodiments of the present invention, the communication device may receive the vehicle information and the battery information from an OTA update-target vehicle when an OTA update event occurs.

According to various aspects of the present invention, a method of controlling an over-the-air (OTA) update of a vehicle includes collecting vehicle information and battery information from the plurality of vehicles by a controller, determining an optimal OTA update-target for each of the vehicles by the controller, based on the vehicle information and the battery information, and transmitting the optimal OTA update-target and corresponding update data to each of the vehicles by a communication device.

In another exemplary embodiment of the present invention, the determining of the optimal OTA update-target for each of the vehicles may include detecting a reference current corresponding to the vehicle information and a spare capacity corresponding to the battery information, determining an amount of power consumed by each update-target ECU for each update time, and determining a final update-target ECU in descending order of priority, based on the amount of power consumed by each update-target electronic control unit (ECU), compared to the spare capacity.

In another exemplary embodiment of the present invention, the detecting of the spare capacity corresponding to the battery information may include determining as the spare capacity, a result capacity obtained by subtracting a standby power capacity and a starting power capacity from an available power capacity corresponding to a state of charge (SOC) value of a battery.

In another exemplary embodiment of the present invention, the detecting of the spare capacity corresponding to the battery information may include determining a final spare capacity by further considering durability of the battery in addition to the spare capacity.

In another exemplary embodiment of the present invention, the determining of the amount of the consumed power may include determining the amount of power consumed by each update-target ECU, based on the reference current of each of the vehicles and estimated time required for updating each update-target ECU positioned in each of the vehicles.

In another exemplary embodiment of the present invention, the determining of the final update-target ECU may include determining an ECU that satisfies the spare capacity of a battery as the final update-target ECU, based on the priority of each update-target ECU in the OTA update, in a process in which the amounts of power consumed by the ECUs for the OTA update are summed together in order of an ECU having higher priority to an ECU having lower priority.

In another exemplary embodiment of the present invention, the collecting of the vehicle information and the battery information may include receiving the vehicle information and the battery information from an OTA update-target vehicle when an OTA update event occurs.

In another exemplary embodiment of the present invention, the method may further include outputting the optimal OTA update-target for each of the vehicles by an output device.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is an exemplary view showing a system for controlling an over-the-air (OTA) update of a vehicle according to various exemplary embodiments of the present invention;

FIG. 2 is a configuration view showing an apparatus of controlling the OTA update of a vehicle according to various exemplary embodiments of the present invention;

FIG. 3 is a flowchart showing a method of controlling an OTA update of a vehicle according to various exemplary embodiments of the present invention;

FIG. 4 is a detailed flowchart showing the method of controlling the OTA update of a vehicle according to various exemplary embodiments of the present invention; and

FIG. 5 is a block diagram showing a computing system implementing the method of controlling the OTA update of a vehicle according to various exemplary embodiments of the present invention.

It may be understood that the appended drawings are not necessarily to scale, presenting a somewhat simplified representation of various features illustrative of the basic principles of the present invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, embodiments of the present invention will be described in detail with reference to the accompanying drawings. In the drawings, the same reference numbers will be used throughout to designate the same or equivalent components. Furthermore, a detailed description of well-known features or functions will be ruled out in order not to unnecessarily obscure the gist of the present invention.

Terms ‘first,’ ‘second,’ A, B, (a), (b) or the like, may be used in describing components of the exemplary embodiments of the present invention. These terms are only used to distinguish any components from other components, and the features, sequences or the like of the corresponding components are not limited by these terms. Unless otherwise defined, all terms used herein, including technical or scientific terms, have the same meanings as those generally understood by those skilled in the art to which various exemplary embodiments of the present invention pertains. Such terms as those defined in a generally-used dictionary are to be interpreted as having meanings equal to the contextual meanings in the relevant field of art, and are not to be interpreted as having ideal or excessively formal meanings unless clearly defined as having such in the present application.

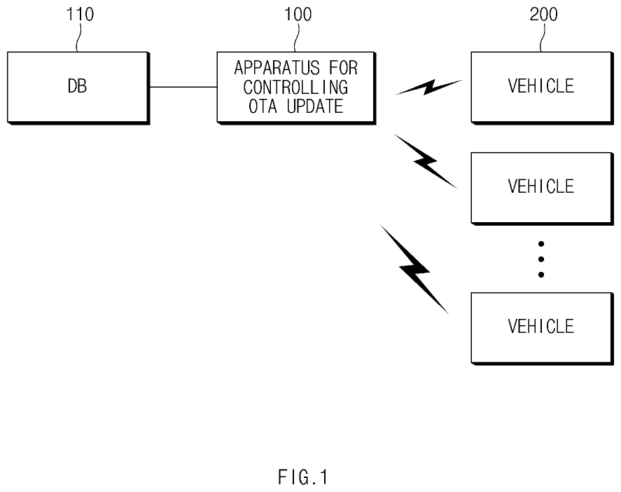

FIG. 1 is an exemplary view showing a system for controlling an over-the-air (OTA) update of a vehicle according to various exemplary embodiments of the present invention.

As shown in FIG. 1, the system for controlling the OTA update of a vehicle according to various exemplary embodiments of the present invention may include an apparatus 100 for controlling an OTA update of a vehicle, a database (DB) 110 and a plurality of vehicles 200.

The apparatus 100 for controlling the OTA update may determine an optimal OTA update-target even for a different vehicle type and a different option for each vehicle type by collecting vehicle information and battery information from the plurality of vehicles 200, and by determining the optimal OTA update-target for each vehicle, based on the vehicle information and the battery information.

The apparatus 100 for controlling the OTA update may determine an optimal update-target electronic control unit (ECU) even for the different vehicle type and the different option for each vehicle type by collecting the vehicle information and the battery information from the plurality of vehicles 200, by detecting a reference current corresponding to the vehicle information and a spare capacity corresponding to the battery information, by determining an amount of power consumed by each update-target ECU for each update time, and by determining a final update-target ECU in descending order of priority, based on the amount of power consumed by each update-target ECU, compared to the spare capacity.

The DB 110 may be a database managed by the apparatus 100 for controlling the OTA update, and may store data (i.e., update data) to update software of each ECU positioned in the vehicle 200.

The vehicle 200 may periodically transmit the vehicle information and the battery information to the apparatus 100 for controlling the OTA update, or transmit the vehicle information and the battery information to the apparatus 100 for controlling the OTA update when receiving an OTA update event from the apparatus 100 for controlling the OTA update. Here, the vehicle information may include information on the vehicle type or information on an option for each vehicle type, and the battery information may include the state of charge (SOC), temperature or durability of a battery. Here, the durability of the battery may be determined in consideration of its production year, vehicle installation month, usage time, etc.

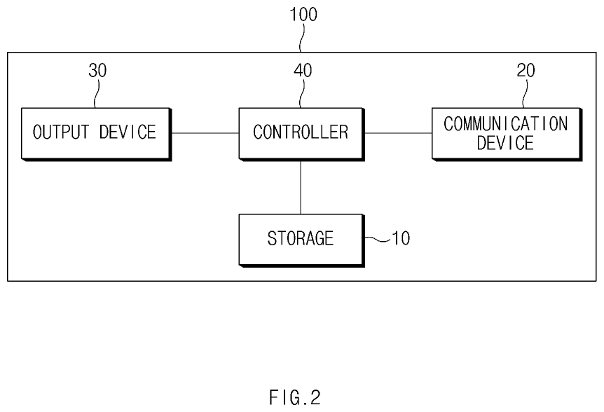

FIG. 2 is a configuration view showing the apparatus of controlling the OTA update of a vehicle according to various exemplary embodiments of the present invention.

As shown in FIG. 2, the apparatus 100 for controlling the OTA update of a vehicle according to various exemplary embodiments of the present invention may include a storage 10, a communication device 20, an output device 30 and a controller 40. Here, each component may be coupled with each other and implemented as one, or some components may be omitted depending on a method for implementing the apparatus 100 for controlling the OTA update of a vehicle according to various exemplary embodiments of the present invention.

Described here is each of the above components. First, the storage 10 may store various logics, algorithms and programs, which are required in processes of collecting the vehicle information and the battery information from the plurality of vehicles 200, and determining the optimal OTA update-target for each vehicle, based on the vehicle information and the battery information.

The storage 10 may store the various logics, the algorithms and the programs, which are required in the processes of collecting the vehicle information and the battery information from the plurality of vehicles 200, detecting the reference current corresponding to the vehicle information and the spare capacity corresponding to the battery information, determining the amount of power consumed by each update-target ECU for each update time, and determining the final update-target ECU in the descending order of priority, based on the amount of power consumed by each update-target ECU, compared to the spare capacity.

The storage 10 may store a table showing the reference current corresponding to the vehicle type and the option for each vehicle type. The reference current may here refer to a current consumed for the OTA update, and the table may be Table 1 below for example.

TABLE 1

| Vehicle type | Option | Reference current |
|---|---|---|
| A | a, b, c | I_{A1} |
| | a, d | I_{A2} |
| | . | . |
| | . | . |
| | . | . |
| B | a, c | I_{B1} |
| | f | I_{B2} |
| . | . | . |
| . | . | . |
| . | . | . |

The option may here refer to a device added to a default vehicle, and may include, for example, a light emitting diode (LED) headlight, a panoramic sunroof, an electric seat adjuster, an adaptive front light system (AFLS), a lane keeping assist system (LKAS), an advanced driver assistance systems (ADAS), an electro chromic mirror (ECM) or a smart parking assist system (SPAS).

The storage 10 may store the table showing the priority of each update-target ECU, positioned in the vehicle 200, in the OTA update. Here, the ECU having higher priority may be an ECU directly involved in driving of the vehicle 200.

The storage 10 may include at least one type of a storage medium among types of memories such as a flash memory, a hard disk memory, a micro memory and a card memory (e.g., secure digital (SD) card and extreme digital (XD) card), or types of memories such as a random access memory (RAM), a static RAM (SRAM), a read-only memory (ROM), a programmable ROM (PROM), an electrically erasable PROM (EEPROM), a magnetic memory (or a magnetic RAM (MRAM)), a magnetic disk and an optical disk memory.

The communication device 20 is a module that provides a communication interface with the vehicle 200. The communication device 20 may periodically receive the vehicle information and the battery information from the plurality of vehicles 200, or may receive the vehicle information and the battery information from the plurality of vehicles 200 when the OTA update event occurs.

The communication device 20 may transmit the optimal OTA update-target and the corresponding update data to each vehicle 200.

The communication device 20 may include at least one of a mobile communication module, a wireless internet module or a near-field communication module.

The mobile communication module may communicate with the vehicle 200 through mobile communication network constructed based on a technical standard or a communication method for mobile communication (e.g., global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE) or long term evolution-advanced (LTE-A)).

The wireless internet module is a module for wireless internet access, and may communicate with the vehicle 200 through wireless local area network (i.e., wireless LAN (WLAN)), wireless-fidelity (Wi-Fi), wireless fidelity (Wi-Fi) direct, digital living network alliance (DLNA), wireless broadband (WiBro), Worldwide Interoperability for Microwave Access (WiMAX), high speed downlink packet access (HSDPA), high speed uplink packet access (HSUPA), long term evolution (LTE), long term evolution-advanced (LTE-A), etc.

The near-field communication module may support short-range communication with the vehicle 200 by use of at least one technology of Bluetooth™, radio frequency identification (RFID), infrared data association (IrDA), ultra wideband (UWB), zigbee, near-field communication (NFC) or wireless universal serial bus (USB).

The output device 30 may output various information provided to a manager during a process of the OTA update. The output device 30 may output the optimal OTA update-target for each vehicle 200, determined by the controller 40. The manager may thus monitor the process of the OTA update by use of the output device 30.

The controller 40 may control each component overall for each component to normally perform its function. The controller 40 may be implemented in a form of hardware, or may be implemented in a form of software, or may be implemented in a form of the hardware and the software in combination. The controller 40 may be implemented as a microprocessor, and is not limited thereto.

The controller 40 may control various components in the processes of collecting the vehicle information and the battery information from the plurality of vehicles 200, and determining the optimal OTA update-target for each vehicle, based on the vehicle information and the battery information.

The controller 40 may control the various components in the processes of collecting the vehicle information and the battery information from the plurality of vehicles 200, detecting the reference current corresponding to the vehicle information and the spare capacity corresponding to the battery information, determining the amount of power consumed by each update-target ECU for each update time, and determining the final update-target ECU in the descending order of priority, based on the amount of power consumed by each update-target ECU, compared to the spare capacity.

An operation of the controller 40 is hereinafter described in detail.

The controller 40 may allow the communication device 20 to collect the vehicle information and the battery information from the plurality of vehicles 200. Here, the vehicle information may include the information on the vehicle type and the information on the option for each vehicle type, and the battery information may include the state of charge (SOC), temperature and durability of the battery.

The controller 40 may allow the communication device 20 to periodically receive the vehicle information and the battery information from the plurality of vehicles 200, or to receive the vehicle information and the battery information from the plurality of vehicles 200 when the OTA update event occurs.

The controller 40 may detect the reference current corresponding to the vehicle information obtained from each vehicle 200, based on the table stored in the storage 10.

The controller 40 may detect the spare capacity of the battery positioned in each vehicle 200, based on the battery information obtained from each vehicle 200. Here, the spare capacity may be a power capacity in consideration of a standby power capacity and a starting power capacity. That is, the controller 40 may determine, as the spare capacity, a result capacity obtained by subtracting the standby power capacity and the starting power capacity from an available power capacity corresponding to the SOC value of the battery. Furthermore, the controller 40 may determine a final spare capacity by further considering the durability of the battery in addition to the spare capacity. For example, as shown in Table 2 below, the spare capacity may be made slightly lower when the battery has high durability, and may made significantly lower the spare capacity when the battery has low durability.

TABLE 2

| Durability | Spare capacity reduction |
|---|---|
| High | 3% |
| Medium | 10% |
| Low | 20% |

The controller 40 may determine the amount of power consumed by each update-target ECU, based on the reference current of each vehicle 200 and time required for performing the OTA update of the update-target ECU positioned in each vehicle 200 (i.e., estimated time for updating each ECU). That is, the controller 40 may determine the amount of the consumed power by multiplying the reference current by the time.

The controller 40 may determine an ECU that satisfies the spare capacity of the battery as the optimal OTA update-target, based on the priority of each ECU in the OTA update, stored in the storage 10, in a process in which the amounts of the consumed power are summed together in order of the ECU having higher priority to an ECU having lower priority.

For example, the controller 40 may determine an ECU A and an ECU B as the optimal OTA update-target when 3 is power consumed by the ECU A having the highest priority, 5 is power consumed by the ECU B having the second highest priority, 4 is power consumed by an ECU C having the third highest priority, and 10 is the spare capacity of the battery. The reason is that summed amounts of power consumed by the ECU A and the ECU B are not more than the spare capacity.

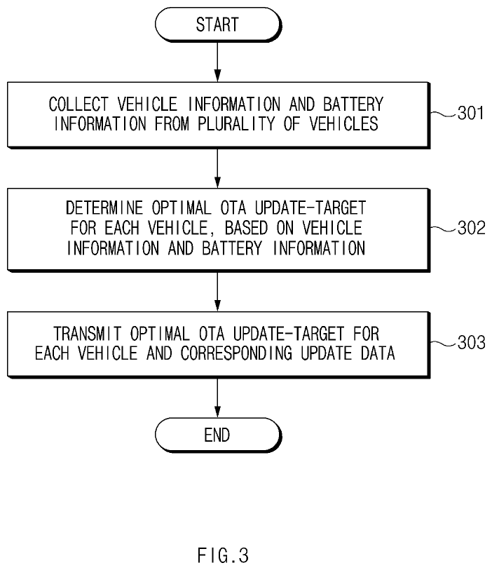

FIG. 3 is a flowchart showing a method of controlling an over-the-air (OTA) update of a vehicle according to various exemplary embodiments of the present invention.

First, a controller 40 may collect vehicle information and battery information from the plurality of vehicles (301).

Next, the controller 40 may determine an optimal OTA update-target for each vehicle, based on the vehicle information and the battery information (302). Here, the controller 40 may detect a reference current corresponding to the vehicle information and a spare capacity corresponding to the battery information, may determine an amount of power consumed by each update-target electronic control unit (ECU) for each update time, and may determine a final update-target ECU in descending order of priority, based on the amount of power consumed by each update-target ECU, compared to the spare capacity.

Next, the communication device 20 may transmit the optimal OTA update-target for each vehicle and corresponding update data (303).

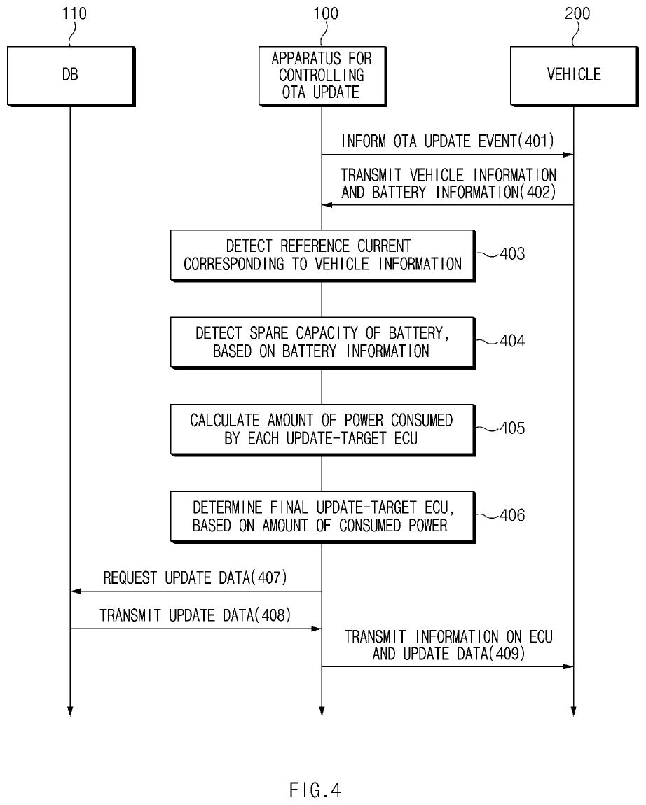

FIG. 4 is a detailed flowchart showing the method of controlling the OTA update of a vehicle according to various exemplary embodiments of the present invention.

First, an apparatus 100 for controlling an OTA update of a vehicle may inform a vehicle 200 that an OTA update event occurs (401).

Accordingly, the vehicle 200 may transmit the vehicle information and the battery information to the apparatus 100 for controlling the OTA update (402). Here, the vehicle 200 may also periodically transmit the vehicle information and the battery information to the apparatus 100 for controlling the OTA update regardless of whether the OTA update event occurs.

Next, the apparatus 100 for controlling the OTA update may detect the reference current corresponding to the vehicle information (403).

Next, the apparatus 100 for controlling the OTA update may detect the spare capacity of the battery, based on the battery information (404).

Next, the apparatus 100 for controlling the OTA update may determine the amount of power consumed by each update-target ECU (405).

Next, the apparatus 100 for controlling the OTA update may determine the final update-target ECU, based on the amount of the consumed power (406). The final update-target ECU determined in the instant way may be set as the optimal OTA update-target.

Next, the apparatus 100 for controlling the OTA update may request the update data from the database (DB) 110 (407), and may thus obtain the update data (408).

Next, the apparatus 100 for controlling the OTA update may transmit the optimal OTA update-target and the corresponding update data to the vehicle 200 (409).

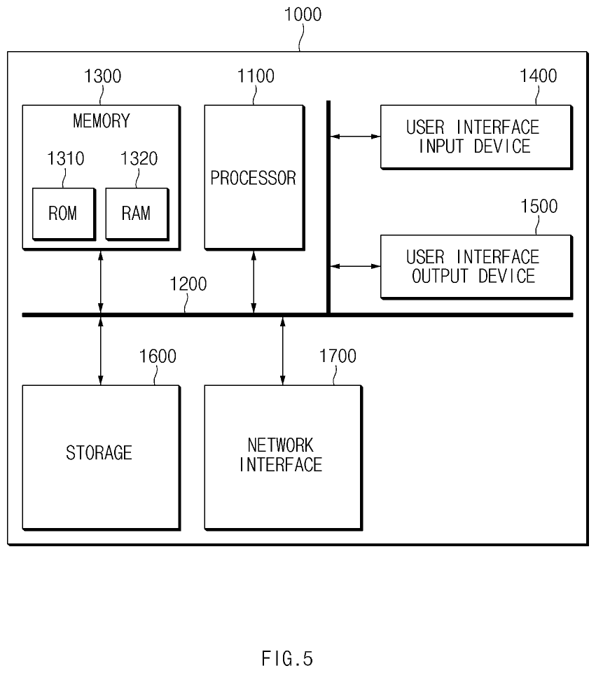

FIG. 5 is a block diagram showing a computing system implementing the method of controlling the OTA update of a vehicle according to various exemplary embodiments of the present invention.

Referring to FIG. 5, the computing system may also implement the method of controlling the OTA update of a vehicle according to various exemplary embodiments of the present invention. A computing system 1000 may include at least one processor 1100, a memory 1300, a user interface input device 1400, a user interface output device 1500, a storage 1600 and a network interface 1700, which are connected to each other by a system bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

The operations of the method or the algorithm described in connection with the exemplary embodiments included in various exemplary embodiments of the present invention may thus be embodied directly in a hardware module, a software module or a combination thereof, controlled by the processor 1100. The software module may reside on a storage medium (i.e., the memory 1300 and/or the storage 1600) such as a random access memory (RAM), a flash memory, a read only memory (ROM), an erasable programming ROM (EPROM), an electrically erasable programming ROM (EEPROM), a register, a hard disk, a solid state drive (SSD), a removable disk or a compact disk-ROM (CD-ROM). An exemplary storage medium may be coupled to the processor 1100, and the processor 1100 may thus read information out of the storage medium and may record information in the storage medium. Alternatively, the storage medium may be integrated with the processor 1100. The processor and the storage medium may reside in an application specific integrated circuit (ASIC). The ASIC may reside in a user terminal. In another case, the processor and the storage medium may reside in the user terminal as individual components.

As set forth above, the apparatus of controlling the OTA update of a vehicle and a method thereof, according to the exemplary embodiments of the present invention, may determine the optimal OTA update-target even for a different vehicle type and a different option for each vehicle type by collecting the vehicle information and the battery information from the plurality of vehicles, and by determining the optimal OTA update-target for each vehicle, based on the vehicle information and the battery information.

The apparatus of controlling the OTA update of a vehicle and a method thereof, according to the exemplary embodiments of the present invention, may determine the optimal update-target ECU even for a different vehicle type and a different option for each vehicle type by collecting the vehicle information and the battery information from the plurality of vehicles, by detecting the reference current corresponding to the vehicle information and the spare capacity corresponding to the battery information, by determining the amount of power consumed by each update-target ECU for each update time, and by determining the final update-target ECU in the descending order of priority, based on the amount of power consumed by each update-target ECU, compared to the spare capacity.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. An apparatus of controlling an over-the-air (OTA) update of a vehicle, the apparatus comprising:
a controller configured to:
collect vehicle information and battery information from a plurality of vehicles, and
determine an optimal OTA update-target for each of the vehicles, according to the vehicle information and the battery information; and
a communication device configured to transmit the optimal OTA update-target and corresponding update data to each of the vehicles.

2. The apparatus of claim 1, wherein the controller is configured to:
detect a reference current corresponding to the vehicle information and a spare capacity corresponding to the battery information,
determine an amount of power consumed by each update-target electronic control unit (ECU) for each update time, and
determine a final update-target ECU in descending order of priority, based on the amount of power consumed by each update-target ECU, compared to the spare capacity.

3. The apparatus of claim 2, wherein the controller is configured to determine, as the spare capacity, a result capacity obtained by subtracting a standby power capacity and a starting power capacity from an available power capacity corresponding to a state of charge (SOC) value of a battery.

4. The apparatus of claim 3, wherein the controller is configured to determine a final spare capacity by further considering durability of the battery in addition to the spare capacity.

5. The apparatus of claim 2, wherein the controller is configured to determine the amount of power consumed by each update-target ECU, based on the reference current of each of the vehicles and estimated time required for updating each update-target ECU positioned in each of the vehicles.

6. The apparatus of claim 2, wherein the controller is configured to determine an ECU that satisfies the spare capacity of a battery as the final update-target ECU, based on the priority of each update-target ECU in the OTA update, in a process in which the amounts of power consumed by the ECUs for the OTA update are summed together in order of an ECU having higher priority to an ECU having lower priority.

7. The apparatus of claim 1, wherein the vehicle information includes at least one of information on a vehicle type or information on an option for each vehicle type.

8. The apparatus of claim 1, wherein the battery information includes at least one of state of charge (SOC), temperature or durability of a battery.

9. The apparatus of claim 1, wherein the communication device is configured to receive the vehicle information and the battery information from an OTA update-target vehicle when an OTA update event occurs.

10. The apparatus of claim 1, further including an output device that outputs the optimal OTA update-target for each of the vehicles.

11. A method of controlling an over-the-air (OTA) update of a vehicle, the method comprising:
collecting, by a controller, vehicle information and battery information from a plurality of vehicles;
determining, by the controller, an optimal OTA update-target for each of the vehicles, according to the vehicle information and the battery information; and
transmitting, by a communication device, the optimal OTA update-target and corresponding update data to each of the vehicles.

12. The method of claim 11, wherein the determining of the optimal OTA update-target for each of the vehicles includes:
detecting a reference current corresponding to the vehicle information and a spare capacity corresponding to the battery information;
determining an amount of power consumed by each update-target electronic control unit (ECU) for each update time; and
determining a final update-target ECU in descending order of priority, based on the amount of power consumed by each update-target ECU, compared to the spare capacity.

13. The method of claim 12, wherein the detecting of the spare capacity corresponding to the battery information includes determining, as the spare capacity, a result capacity obtained by subtracting a standby power capacity and a starting power capacity from an available power capacity corresponding to a state of charge (SOC) value of a battery.

14. The method of claim 13, wherein the detecting of the spare capacity corresponding to the battery information includes determining a final spare capacity by further considering durability of the battery in addition to the spare capacity.

15. The method of claim 12, wherein the determining of the amount of the consumed power includes determining the amount of power consumed by each update-target ECU, based on the reference current of each of the vehicles and estimated time required for updating each update-target ECU positioned in each of the vehicles.

16. The method of claim 12, wherein the determining of the final update-target ECU includes determining an ECU that satisfies the spare capacity of a battery as the final update-target ECU, based on the priority of each update-target ECU in the OTA update, in a process in which the amounts of power consumed by the ECUs for the OTA update are summed together in order of an ECU having higher priority to an ECU having lower priority.

17. The method of claim 11, wherein the vehicle information includes at least one of information on a vehicle type or information on an option for each vehicle type.

18. The method of claim 11, wherein the battery information includes at least one of state of charge (SOC), temperature or durability of a battery.

19. The method of claim 11, wherein the collecting of the vehicle information and the battery information includes receiving the vehicle information and the battery information from an OTA update-target vehicle when an OTA update event occurs.

20. The method of claim 11, further including outputting the optimal OTA update-target for each of the vehicles by an output device.
